(19) United States
(12) Patent Application Publication
(10) Pub. No.: US 2022/0207372 A1
(43) Pub. Date: Jun. 30, 2022

(54) PATTERN-BASED NEURAL NETWORK PRUNING

(71) Applicant: Cypress Semiconductor Corporation, San Jose, CA (US)

(72) Inventor: Ashutosh Pandey, Irvine, CA (US)

(73) Assignee: Cypress Semiconductor Corporation, San Jose, CA (US)

(21) Appl. No.: 17/134,095

(22) Filed: Dec. 24, 2020

(51) Int. Cl. G06N 3/08; G06K 9/62; G06F 17/16

(52) U.S. Cl. CPC G06N 3/082; G06F 17/16; G06K 9/6228

(57) ABSTRACT

An example method for pattern-based pruning of neural networks comprises: receiving, by a processing device, a plurality of feature maps produced by an input layer of a neural network; for each feature map of the plurality of feature maps, selecting, from a predetermined set of pruning masks, a pruning mask to be applied to the feature map; pruning the neural network by applying, to each feature map of the plurality of feature maps, a respective selected pruning mask to the feature map; and training the pruned neural network.

### BACKGROUND

“Neural network” herein shall refer to a computational model which may be implemented by software, hardware, or a combination thereof. A neural network includes multiple inter-connected nodes called “artificial neurons,” which loosely simulate the neurons of a living brain. An artificial neuron processes a signal received from another artificial neuron and transmits the transformed signal to other artificial neurons. The output of each artificial neuron may be represented by a combination of one or more linear and/or non-linear operations performed on its inputs.

### BRIEF DESCRIPTION OF THE DRAWINGS

The present disclosure is illustrated by way of example, and not of limitation, in the figures of the accompanying drawings in which:

FIG. 1 schematically illustrates an example neural network implemented in accordance with aspects of the present disclosure.

FIG. 2 schematically illustrates a set of feature maps generated by the input layer of an example neural network operating in accordance with aspects of the present disclosure.

FIG. 3 schematically illustrates a set of pruning patterns for pruning a neural network, in accordance with aspects of the present disclosure.

FIG. 4 schematically illustrates a flow chart of an example method of generating a computationally-efficient neural network, in accordance with aspects of the present disclosure.

FIG. 5 schematically illustrates the pruning process, in accordance with aspects of the present disclosure.

FIG. 6 illustrates a diagrammatic representation of a machine in the example form of a computing system within which a set of instructions, for causing the machine to perform any one or more of the methods discussed herein, may be executed

### DETAILED DESCRIPTION

The embodiments described herein are directed to systems and methods for pattern-based pruning of neural networks. The methods and systems of the present disclosure may be used, for example, for implementing user voice identification techniques, for wake-up phrase detection and to process voice commands.

A wake-up phrase can include one or more predefined words that precede at least some of voice commands processed by a voice-operated device. The latter may be represented by a smart speaker, a smart phone, a wearable device, or a similar computing device which is usually equipped with one or more general purpose processors. While certain voice recognition tasks can be performed by a server to which the voice-operated device can communicate via one or more wired and/or wireless networks, the wake-up phrase detection is, in some implementations, performed by the voice-operated device locally (e.g., in order to reduce the latency and the amount of network traffic between the voice-operated device and the server). Accordingly, voice recognition methods that are employed by voice-operated devices for wake-up phrase detection should be capable of being performed on general purpose compute engines (e.g., without utilizing graphic processing units (GPUs) or other specialized processing devices).

Voice recognition systems can employ trainable models (also known as machine learning-based models) for converting speech represented by audio signals to text including a sequence of natural language words. In some implementations, a trainable model employed for voice recognition can be implemented by one or more neural networks.

A neural network is a computational model that includes multiple inter-connected nodes called “artificial neurons,” which loosely simulate the neurons of a living brain. An artificial neuron processes a signal received from another artificial neuron and transmit the transformed signal to other artificial neurons. The output of each artificial neuron may be represented by a combination of one or more linear and/or non-linear operations performed on its inputs.

Edge weights, which increase or attenuate the signals being transmitted through respective edges connecting the neurons, as well as other network parameters, may be determined at the network training stage, by employing supervised and/or unsupervised training methods. In an illustrative example, all the edge weights are initialized to random values. For every input in the training dataset, the neural network is activated. The observed output of the neural network is compared with the desired output specified by the training data set, and the error is propagated back to the previous layers of the neural network, in which the weights are adjusted accordingly. This process is repeated until the observed error is below a predetermined threshold.

An example neural network may include an input layer, one or more intermediate layers, and an output layer. Thus, each neuron of the input layer is connected to one or more neurons of an intermediate layer. In turn, each neuron of the intermediate layer may be connected to one or more neurons of another intermediate layer or the output layer. The number of connections between neurons, which may directly affect the quality of voice recognition, is also the main contributing factor to the overall computational complexity of implementing the neural network.

In various neural network implementations for voice recognition, the input layer learns the patterns along the time and frequency coordinates of the signal, rather than performing any classification or regression tasks. As long as these learned patterns capture the essential patterns in the input data, the subsequent layers can perform the classification and/or regression tasks.

However, not all the nodes of the input layer are necessary to learn such patterns. Accordingly, in order to force the input layer to selectively learn different parts of the input data, a trained baseline neural network may be pruned in order to reduce the number of artificial neuron connections.

“Pruning” herein refers to a method of modifying a neural network structure by permanently dropping some artificial neuron connections from the network, and thus reducing the overall computational complexity of implementing the neural network. In order to further reduce the computational complexity of the resulting neural network, the systems and methods of the present disclosure implement a pruning process which utilizes a set of predetermined patterns, thus exploiting the structural sparsity of the resulting neural network for further reducing its computational complexity.

The adverse effect of pruning on the network performance may be compensated by retraining the network, which may restore some of the pruned connections. The resulting neural network may thus be suitable for deploying on voice-operated devices equipped with general purpose processors and/or on other hardware platforms having limited computational capacity and/or available memory.

Various aspects of the methods and systems are described herein by way of examples, rather than by way of limitation. The methods described herein may be implemented by hardware (e.g., general purpose and/or specialized processing devices, and/or other devices and associated circuitry), software (e.g., instructions executable by a processing device), or a combination thereof.

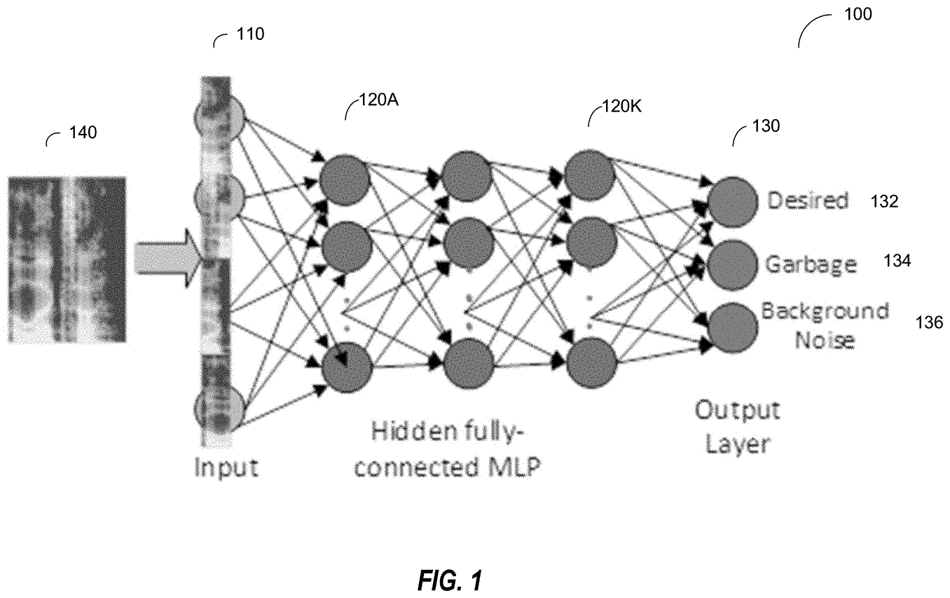

FIG. 1 schematically illustrates an example neural network implemented in accordance with aspects of the present disclosure. As shown in FIG. 1, the neural network 100 is represented by a multi-layer perceptron, which includes the input layer 110, the intermediate layers 120A-120K, and the output layer 130. The neural network 100 can be trained to process the input data 140 (e.g., represented by a digitized audio stream) in order to recognize one or more pre-determined wake-up phrases.

The input layer 110 may extract or refine the features from the input data by applying, to the input data, one or more trainable filters implemented by the nodes of the input layer, thus producing a feature map that represents the responses of the filters at every portion of the input data represented in the time-frequency coordinates. Each filter may implement a combination of one or more linear or non-linear operations. The filters may be defined at the network training stage.

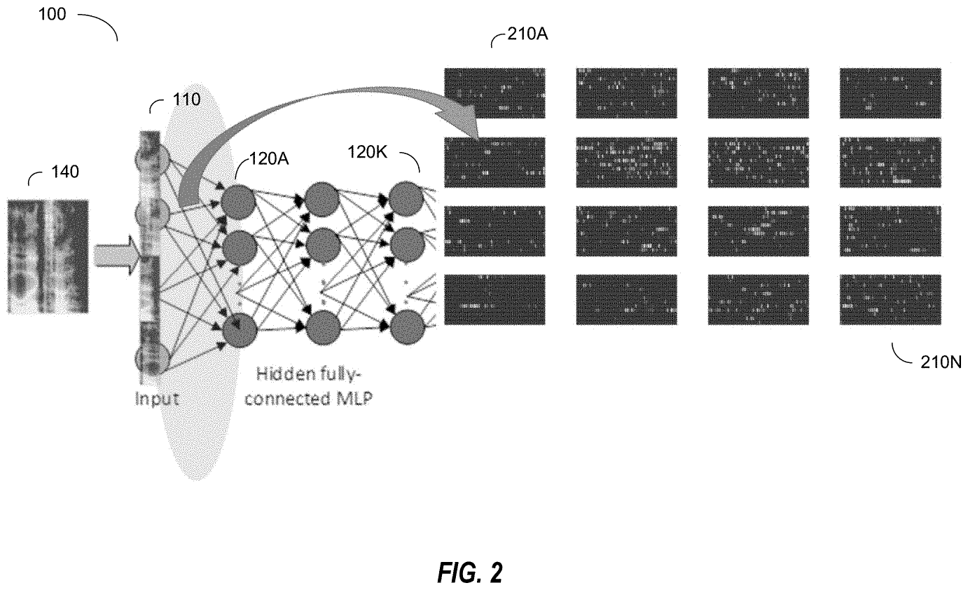

Thus, the input layer 110 essentially learns the patterns that reflect certain input data features that are significant for the classification and/or regression tasks, which are then performed by the subsequent layers of the neural network 100. Accordingly, assuming that the input layer performs an injective and structure-preserving transformation of the input data into a set of feature maps represented by integer matrices, the feature maps produced by the input layer can be termed “speech embeddings” or “wake word embeddings” for wake word detection tasks. FIG. 2 schematically shows a set of feature maps 210A-210N generated by the input layer 110 of the neural network 100 operating in accordance with aspects of the present disclosure.

As long as the feature maps produced by the input layer capture the essential patterns in the input data, the subsequent layers can perform the classification and/or regression tasks. However, not all the nodes of the input layer are necessary to learn such patterns. Referring again to FIG. 1, the nodes of the output layer 130 may represent the desired output (i.e., recognized wake-up phrases) 132, as well as other portions of the input audio stream (“garbage”) 134, and the background noise 136.

Accordingly, in order to force the input layer to selectively learn different parts of the input data, a trained baseline neural network may be pruned in order to reduce the number of artificial neuron connections. However, extensive pruning may limit the network's learning capability. Thus, in order to produce a functional network while managing the computational complexity, a baseline network may be trained and then pruned by permanently dropping less significant connections. The adverse effect of pruning on the network performance may be compensated by retraining the network, which may restore some of the pruned connections. Thus, the resulting pruned network inherits the knowledge acquired by the baseline network, while exhibiting much lighter computational complexity, while directly learning a complex function with a lightweight network may not have yielded acceptable results.

In order to minimize the adverse effect of pruning on the network performance, the pruning process needs to select less significant connection combinations as pruning candidates. Since the speech embeddings produced by the input layer efficiently learn localized patterns in the time-and-frequency coordinates of the input data, but not all connections are needed to learn those patterns, the systems and methods of the present disclosure force the neural network to the input layer to selectively learn different parts of the input data by performing pattern-based pruning. The pruning process utilizes a set of predetermined patterns (pruning masks), which may have a regular structure and thus significantly reduces the computational complexity of the resulting neural network by exploiting the structural sparsity, which places non-zero parameters at the locations that are defined by the predetermined patterns.

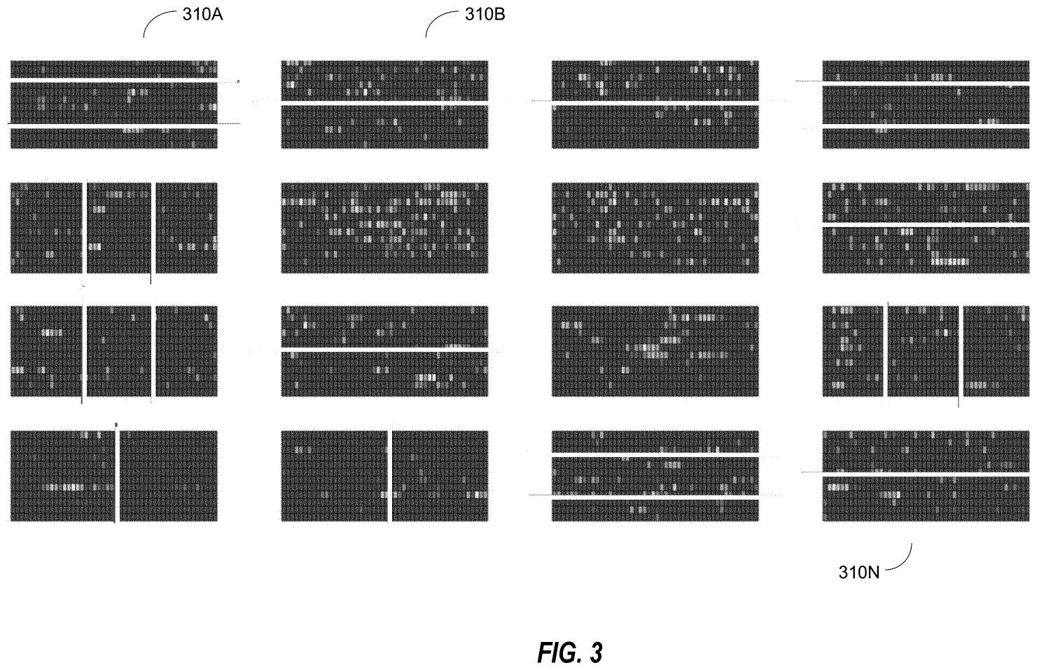

FIG. 3 schematically illustrates a set of pruning masks 310A-310N for pruning a neural network, in accordance with aspects of the present disclosure. In FIG. 3, each pruning mask effectively selects a rectangular area within a respective feature map over which the border lines are overlaid. A pruning mask 310 can be represented by a rectangular matrix having the positions that correspond to the selected feature map values set to a pre-defined value (e.g., “1”), while the remaining positions (i.e., the positions corresponding to the non-selected values) are set to zeroes.

In some implementations, before performing the pattern-based pruning, the baseline neural network may be optimized, e.g., by an L1 and/or L2 regularization process, which adds a term to the error function utilized by the training procedure, such that the additional term decays the weight values (L2 regularization) or penalizes large weight values (L1 regularization).

The regularized network may then be pruned using a predetermined set of pruning masks. In some implementations, the set of pruning masks can include the masks that utilize the example patterns shown in FIG. 3, such that each pruning mask effectively selects a rectangular area within a respective feature map. In various illustrative examples, the selected rectangular area may be the top half, the bottom half, the left half, or the right half of the underlying feature map. In other illustrative examples, the selected area can be a rectangular band intersecting the feature map along a horizontal (time) or vertical (frequency) axis. Alternatively, the set of pruning masks can include the masks that utilize various non-rectangular patterns.

The systems and methods of the present disclosure may select, from the predetermined set of pruning masks, a pruning mask to be applied to each feature map generated by the input layer of a pre-trained baseline neural network. In some implementations, selected is the pruning mask m̅ₖ̅ which, when applied to the feature map, would maximize the sum of the feature map values:

$$\overline{{m}_{k}} = {max}_{m = 1 , … , M} {\sum }_{i , j} {f}_{i j}^{k} {p}_{i j}^{m}$$

where k identifies the feature map for which a pruning mask m̅ₖ̅ is being selected from the set of predetermined pruning masks,

fᵢⱼ^{k} is the feature map value at (i, j) coordinates,

pᵢⱼ^{m} is the corresponding mask value of the m-th mask, m=1, . . . , M

The selected mask m̅ₖ̅ may then be applied to the feature map f^{k} by multiplying each feature map element fᵢⱼ^{k} by the corresponding mask element.

In some implementations, the pruning masks of the predetermined set of pruning masks are mapped to the feature maps in an iterative manner that ensures that the masks are not reused within the same training iteration unless the number of feature maps exceeds the number of available masks. In an illustrative example, this rule is enforced by deleting a selected mask from the set of available masks, such that the mask would not be reused for any other feature map during the same training iteration. Before starting each training iteration, the set of available masks may be restored to include all predetermined masks, and the above-described mask selection procedure may be performed.

Iterative retraining of the neural network may restore some of the pruned connections, and thus may reduce the adverse effect of the pruning process on the network performance. In some implementations, the selected pruning masks may be gradually applied to the neural network over a sequence of training iterations, such that each at each iteration, a decay factor is applied to the mask that has been used at the previous training iteration:

mₖ(t)=αmₖ(t−1)+(1−α)m̅ₖ̅,

where mₖ (0)=P₀ (matrix of “1”s)

t represents a training iteration

α<1 is the decay factor.

The retrained network may be deployed on the target hardware platform and utilized for performing the intended classification and/or regression tasks (e.g., the wake up phrase detection).

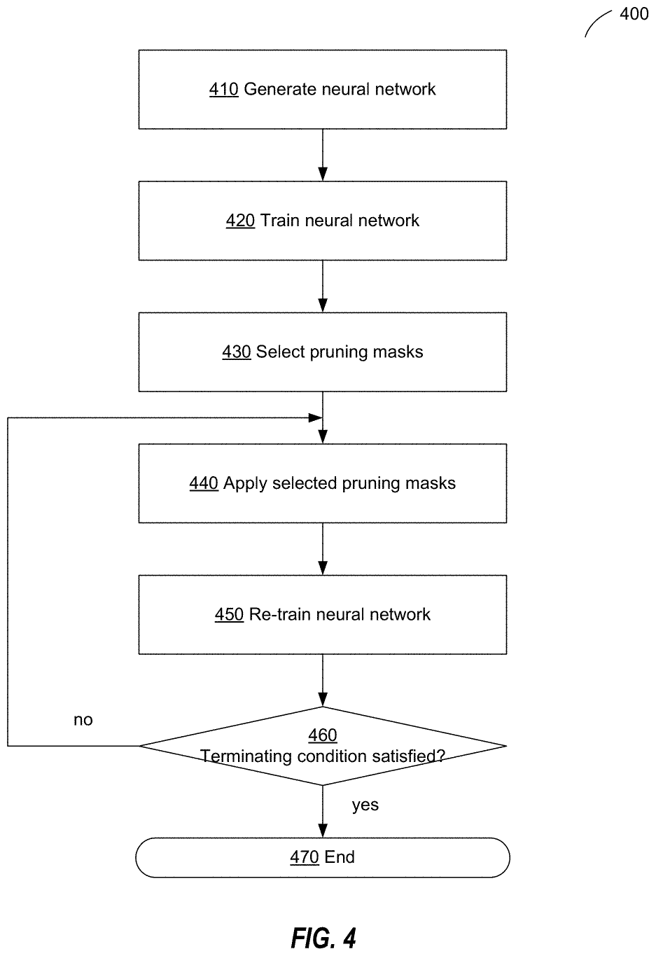

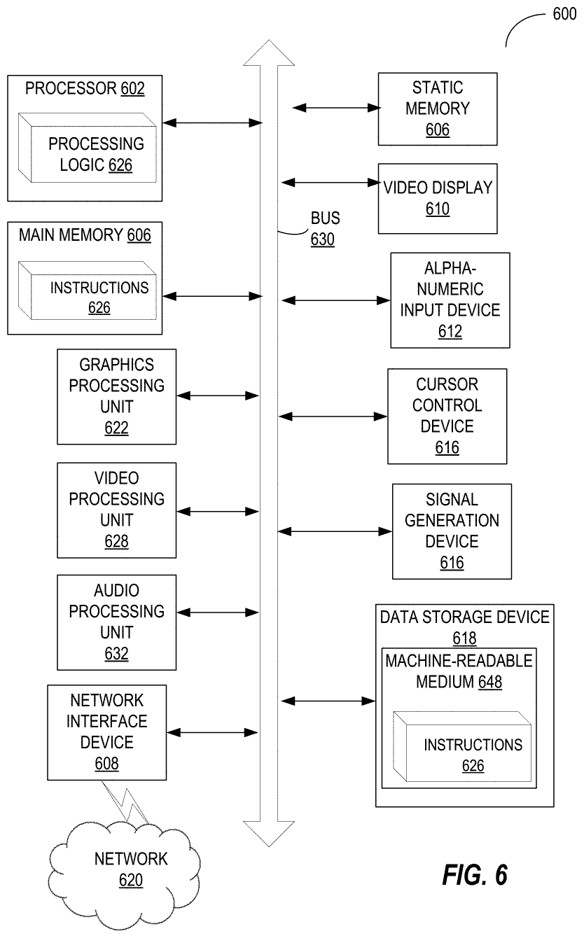

FIG. 4 schematically illustrates a flow chart of an example method of generating a computationally-efficient neural network, in accordance with aspects of the present disclosure. The method 400 and/or each of its individual functions, routines, subroutines, or operations may be performed by processing logic comprising hardware (circuitry, dedicated logic, etc.), software (such as is run on a general purpose computing system or a dedicated machine), firmware (embedded software), or any combination thereof. Two or more functions, routines, subroutines, or operations of method 400 may be performed in parallel or in an order that may differ from the order described below. In certain implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other. In one embodiment, the operations of methods 400 may be performed by the computing system 600 of FIG. 6.

At operation 410, the processing device implementing the method generates a neural network (e.g., a multi-layer perceptron, which includes an input layer, one or more intermediate layers, and the output layer, as schematically illustrated by FIG. 1).

At operation 420, the processing device trains the neural network. In an illustrative example, all the connection weights are initialized to random values. For every input in the training dataset, the neural network is activated. The observed output of the neural network is compared with the desired output specified by the training data set, and the error is propagated back to the previous layers of the neural network, in which the weights are adjusted accordingly. This process is repeated until the observed error is below a predetermined threshold.

In some implementations, the network training process may involve L2 regularization, which adds a term to the error function utilized by the training procedure, such that the additional term penalizes large weight values.

At operation 430-440, the processing device performs the network pruning by applying a predetermined set of pruning masks to the feature maps generated by the input layer of the neural network. In particular, at operation 430, the processing device selects, from the predetermined set of pruning masks, a pruning mask to be applied to each feature map generated by the input layer of the neural network. In some implementations, selected is the pruning mask which, when applied to the feature map, would maximize the sum of the feature map values, as described in more detail herein above. The mask selection procedure is performed for at least a subset of the feature maps generated by the input layer of the neural network.

In some implementations, the selected pruning mask is deleted from the set of available masks, such that the mask would not be reused for any other feature map during the same training iteration. Before starting each training iteration, the set of available masks may be restored to include all predetermined masks, and the above-described mask selection procedure may be performed.

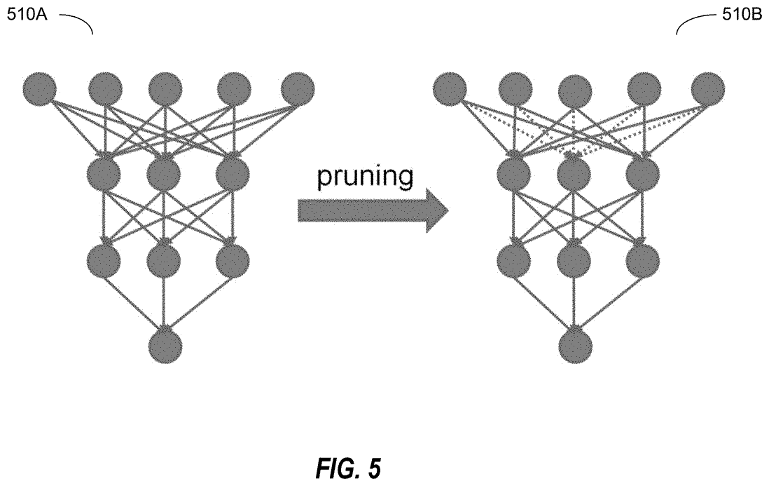

At operation 440, the selected masks are applied to the respective feature maps, by multiplying each feature map element by the corresponding mask element, as described in more detail herein above. FIG. 5 schematically illustrates the pruning process. Pruning the fragment of the original neural network 510A may involve removing the artificial neuron connections that are shown in dashed lines in the resulting fragment of the pruned neural network 510B.

Referring again to FIG. 4, at operation 450, the pruned neural network is retrained. The retraining procedure may restore some of the pruned connections, and thus may reduce the adverse effect of the pruning process on the network performance.

In some implementations, the operations 430-450 may be performed iteratively, such that each iteration would correspond to a training iteration, which involves network pruning and subsequent retraining utilizing a previously unused portion of the training dataset. In some implementations, the selected pruning masks may be gradually applied to the neural network over a sequence of training iterations, such that each at each iteration, a decay factor is applied to the mask that has been used at the previous training iteration, as described in more detail herein above.

At operation 460, the processing device evaluates the terminating condition of the iterative pruning and training process. In an illustrative example, the terminating condition may compare the number of performed iterations to a threshold number. In an illustrative example, the terminating condition may ascertain the availability of training data for performing further training iterations. In yet another illustrative example, the terminating condition may compare the observed error value to a predetermined threshold.

Responsive to determining that the terminating condition is satisfied, the method terminates at operation 470; otherwise, the method loops back to operation 440.

Neural networks generated by the method 400 are suitable for deploying on voice-operated devices equipped with general purpose processors and/or on other hardware platforms having limited computational capacity and/or available memory.

In an illustrative example, neural networks generated by the method 400 may be utilized for voice recognition (e.g., wake-up phrase detection). Alternatively, neural networks generated by the method 400 may be utilized for performing various other classification and/or regression tasks.

FIG. 6 illustrates a diagrammatic representation of a machine in the example form of a computing system 600 within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a host computing system or computer, an automotive computing device, a server, a network device for an automobile network such as a controller area network (CAN) or local interconnected network (LIN), or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computing system 600 includes a processing device 602, main memory 606 (e.g., read-only memory (ROM), flash memory, dynamic random access memory (DRAM) (such as synchronous DRAM (SDRAM) or DRAM (RDRAM), etc.), a static memory 606 (e.g., flash memory, static random access memory (SRAM), etc.), and a data storage device 618, which communicate with each other via a bus 630.

Processing device 602 represents one or more general-purpose processing devices such as a microprocessor device, central processing unit, or the like processing device. More particularly, the processing device may be complex instruction set computing (CISC) microprocessor device, reduced instruction set computer (RISC) microprocessor device, very long instruction word (VLIW) microprocessor device, or processing device implementing other instruction sets, or processing devices implementing a combination of instruction sets. Processing device 602 may also be one or more special-purpose processing devices such as an application specific integrated circuit (ASIC), a field programmable gate array (FPGA), a digital signal processing device (DSP), network processing device, or the like. In one implementation, processing device 602 may include one or more processing device cores. The processing device 602 is configured to execute instructions 626 for performing the operations discussed herein.

The computing system 600 may include other components as described herein. The computing system 600 may further include a network interface device 608 communicably coupled to a network 620. The computing system 600 also may include a video display unit 610 (e.g., a liquid crystal display (LCD)), an alphanumeric input device 612 (e.g., a keyboard), a cursor control device 616 (e.g., a mouse), a signal generation device 616 (e.g., a speaker), or other peripheral devices. Furthermore, computing system 600 may include a graphics processing unit 622, a video processing unit 628 and an audio processing unit 632. In another implementation, the computing system 600 may include a chipset (not illustrated), which refers to a group of integrated circuits, or chips, that are designed to work with the processing device 602 and controls communications between the processing device 602 and external devices. For example, the chipset may be a set of chips on a motherboard that links the processing device 602 to very high-speed devices, such as main memory 606 and graphic controllers, as well as linking the processing device 602 to lower-speed peripheral buses of peripherals, such as USB, PCI, or ISA buses.

The data storage device 618 may include a computer-readable storage medium 648 on which is stored instructions 626 embodying any one or more of the methodologies of functions described herein. The instructions 626 may also reside, completely or at least partially, within the main memory 606 as instructions 626 and/or within the processing device 602 as processing logic during execution thereof by the computing system 600; the main memory 606 and the processing device 602 also constituting computer-readable storage media.

The computer-readable storage medium 648 may also be used to store instructions 626, which, when executed by the processing device 602, cause the processing device to implement the method 400 of generating computationally-efficient neural networks.

While the computer-readable storage medium 648 is shown in an example implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instruction for execution by the machine and that cause the machine to perform any one or more of the methodologies of the implementations. The term “computer-readable storage medium” shall accordingly be taken to include, but not be limited to, solid-state memories, and optical and magnetic media.

In the above description, numerous details are set forth. It will be apparent, however, to one of ordinary skill in the art having the benefit of this disclosure, that embodiments of the present disclosure may be practiced without these specific details. In some instances, well-known structures and devices are shown in block diagram form, rather than in detail, in order to avoid obscuring the description.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one implementation, refers to the hardware, which is specifically configured to recognize and/or execute the code to be held on a non-transitory medium. Furthermore, in another implementation, use of a module refers to the non-transitory medium including the code, which is specifically adapted to be executed by the microcontroller to perform predetermined operations. And as may be inferred, in yet another implementation, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one implementation, use of the term logic includes hardware, such as transistors, registers, or other hardware, such as programmable logic devices.

Use of the phrase ‘configured to,’ in one implementation, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ capable of/to,′ and or ‘operable to,’ in one implementation, refers to some apparatus, logic, hardware, and/or element designed in such a way to enable use of the apparatus, logic, hardware, and/or element in a specified manner. Note as above that use of to, capable to, or operable to, in one implementation, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one implementation, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “adjusting,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example′ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such.

Embodiments described herein may also relate to an apparatus for performing the operations herein. This apparatus may be specially constructed for the required purposes, or it may comprise a general-purpose hardware selectively activated or reconfigured by a firmware stored therein. Such firmware may be stored in a non-transitory computer-readable storage medium, such as, but not limited to, NVMs, read-only memories (ROMs), random access memories (RAMs), EPROMs, EEPROMs, flash memory, or any type of media suitable for storing electronic instructions. The term “computer-readable storage medium” should be taken to include a single medium or multiple media that store one or more sets of instructions. The term “computer-readable medium” shall also be taken to include any medium that is capable of storing, encoding or carrying a set of instructions for execution by the hardware and that causes the hardware to perform any one or more of the methodologies of the present embodiments. The term “computer-readable storage medium” shall accordingly be taken to include, but not be limited to, solid-state memories, optical media, electro-magnetic media, any medium that is capable of storing a set of instructions for execution by hardware and that causes the hardware to perform any one or more of the methodologies of the present embodiments.

The above description sets forth numerous specific details such as examples of specific systems, components, methods and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth above are merely exemplary. Particular embodiments may vary from these exemplary details and still be contemplated to be within the scope of the present disclosure.

It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

In the above description, for purposes of explanation, numerous specific details are set forth in order to provide a thorough understanding of the present disclosure. It will be evident, however, to one skilled in the art that the present disclosure may be practiced without these specific details. In other instances, well-known circuits, structures, and techniques are not shown in detail, but rather in a block diagram in order to avoid unnecessarily obscuring an understanding of this description.

Reference in the description to “one embodiment” or “an embodiment” means that a particular feature, structure, or characteristic described in connection with the embodiment is included in at least one embodiment of the disclosure. The phrase “in one embodiment” located in various places in this description does not necessarily refer to the same embodiment.

What is claimed is:

1. A method, comprising:
receiving, by a processing device, a plurality of feature maps produced by an input layer of a neural network;
for each feature map of the plurality of feature maps, selecting, from a predetermined set of pruning masks, a pruning mask to be applied to the feature map;
pruning the neural network by applying, to each feature map of the plurality of feature maps, a respective selected pruning mask; and
training the pruned neural network.

2. The method of claim 1, further comprising:
deploying the trained neural network on a hardware platform comprising a general purpose processor; and
utilizing the neural network deployed on the hardware platform for performing a voice recognition task.

3. The method of claim 1, wherein each feature map of the plurality of feature maps represents a plurality of responses of the input layer of the neural network at respective portions of input data represented in time-frequency coordinates.

4. The method of claim 1, wherein selecting the pruning mask further comprises:
identifying, among the predetermined set of pruning masks, a pruning mask that, when applied to the feature map, maximizes a sum of values of the feature map.

5. The method of claim 1, wherein selecting the pruning mask further comprises:
removing the selected pruning mask from the predetermined set of pruning masks.

6. The method of claim 1, wherein applying the selected pruning mask to the feature map further comprises:
multiplying each element of the feature map by a corresponding element of the selected pruning mask.

7. The method of claim 1, wherein applying the selected pruning mask to the feature map further comprises:
applying a decay factor to the selected pruning mask.

8. The method of claim 1, further comprising:
responsive to determining that a terminating condition is not satisfied, iteratively repeating the pruning and training operations.

9. A system, comprising:
a memory; and
a processing device, coupled to the memory, the processing device configured to:
receiving a plurality of feature maps produced by an input layer of a neural network;
for each feature map of the plurality of feature maps, select, from a predetermined set of pruning masks, a pruning mask to be applied to the feature map;
prune the neural network by applying, to each feature map of the plurality of feature maps, a respective selected pruning mask; and
train the pruned neural network.

10. The system of claim 9, wherein the processing device is further configured to:
deploy the trained neural network on a hardware platform comprising a general purpose processor; and
utilize the neural network deployed on the hardware platform for performing a voice recognition task.

11. The system of claim 9, wherein each feature map of the plurality of feature maps represents a plurality of responses of the input layer of the neural network at respective portions of input data represented in time-frequency coordinates.

12. The system of claim 9, wherein selecting the pruning mask further comprises:
identifying, among the predetermined set of pruning masks, a pruning mask that, when applied to the feature map, maximizes a sum of values of the feature map.

13. The system of claim 9, wherein selecting the pruning mask further comprises:
removing the selected pruning mask from the predetermined set of pruning masks.

14. The system of claim 9, wherein applying the selected pruning mask to the feature map further comprises:
multiplying each element of the feature map by a corresponding element of the selected pruning mask.

15. The system of claim 9, wherein applying the selected pruning mask to the feature map further comprises:
applying a decay factor to the selected pruning mask.

16. The system of claim 9, wherein the processing device is further configured to:
responsive to determining that a terminating condition is not satisfied, iteratively repeating the pruning and training operations.

17. A non-transitory computer-readable storage medium storing executable instructions which, when executed by a processing device, cause the processing device to:
receive a plurality of feature maps produced by an input layer of a neural network;
for each feature map of the plurality of feature maps, select, from a predetermined set of pruning masks, a pruning mask to be applied to the feature map;
prune the neural network by applying, to each feature map of the plurality of feature maps, a respective selected pruning mask; and
train the pruned neural network.

18. The non-transitory computer-readable storage medium of claim 17, further comprising executable instructions which, when executed by the processing device, cause the processing device to:
deploy the trained neural network on a hardware platform comprising a general purpose processor; and
utilize the neural network deployed on the hardware platform for performing a voice recognition task.

19. The non-transitory computer-readable storage medium of claim 17, wherein selecting the pruning mask further comprises:
identifying, among the predetermined set of pruning masks, a pruning mask that, when applied to the feature map, maximizes a sum of values of the feature map.

20. The non-transitory computer-readable storage medium of claim 17, wherein applying the selected pruning mask to the feature map further comprises:
multiplying each element of the feature map by a corresponding element of the selected pruning mask.
